(19) United States
(12) Patent Application Publication
(10) Pub. No.: US 2014/0144530 A1
(43) Pub. Date: May 29, 2014

(54) WIRELESS POSITION TRANSDUCER FOR A VALVE

(71) Applicant: FISHER CONTROLS INTERNATIONAL LLC, Marshalltown, IA (US)

(72) Inventor: Lorin Dion Miller, Colo, IA (US)

(73) Assignee: FISHER CONTROLS INTERNATIONAL LLC, Marshalltown, IA (US)

(21) Appl. No.: 14/086,102

(22) Filed: Nov. 21, 2013

Related U.S. Application Data
(60) Provisional application No. 61/731,122, filed on Nov. 29, 2012.

(51) Int. Cl. F16K 37/00

(52) U.S. Cl. CPC F16K 37/0041
USPC 137/551; 137/1

(57) ABSTRACT

A wireless position transducer for a valve in a process control system converts a motion or a position of an actuator of the valve into a wireless signal including a value indicative of the position of the actuator. The transducer causes the wireless signal to be transmitted over a wireless communication channel to a valve controller, such as by using a wireless HART protocol. The wireless communication channel is an exclusive connection between the transducer and the controller, and the transducer is powered by a local rechargeable energy storage device. The controller controls the valve based on the value included in the wireless signal. The transducer may also cause the wireless signal to be transmitted to a control host of the process control system.

### CROSS REFERENCE TO RELATED APPLICATIONS

This application claims the benefit of U.S. Provisional Application No. 61/731,122, entitled “Wireless Position Transducer for a Valve” which was filed on Nov. 29, 2012, the entire disclosure of which is hereby incorporated by reference herein.

### FIELD OF THE INVENTION

The present disclosure relates generally to valves and, more particularly, to methods and apparatuses to wirelessly couple a valve and a controller in a process control system.

### BACKGROUND

Electronic control devices (e.g., an electro-pneumatic controller, programmable controllers, analog control circuits, etc.) are typically used to control process control devices (e.g., control valves, pumps, dampers, etc.). These electronic control devices cause a specified operation of the process control devices. For purposes of safety, cost efficiency, and reliability, many well-known diaphragm-type or piston-type pneumatic actuators are used to actuate process control devices and are typically coupled to the overall process control system via an electro-pneumatic controller. Electro-pneumatic controllers are usually configured to receive one or more control signals and convert those control signals into a pressure provided to a pneumatic actuator to cause a desired operation of the process control device coupled to the pneumatic actuator. For example, if a process control routine requires a pneumatically-actuated valve to pass a greater volume of a process fluid, the magnitude of the control signal applied to an electro-pneumatic controller associated with the valve may be increased (e.g., from 10 milliamps (mA) to 15 mA in a case where the electro-pneumatic controller is configured to receive a 4-20 mA control signal).

Electro-pneumatic controllers typically use a feedback signal generated by a feedback sensing system or element (e.g., a position sensor) that senses or detects an operational response of a pneumatically-actuated control device. For example, in the case of a pneumatically-actuated valve, the feedback signal is a feedback current signal corresponding to the position of the valve as measured or determined by a position sensor. Typically, the feedback current signal corresponding to the position of the valve is transmitted to the controller via a wired connection, and the position of the valve is calculated by the controller based on a voltage differential across a resistor at two inputs of the controller.

In some systems, a pneumatically-activated valve is connected in a wired manner to both an electric isolator and to a electro-pneumatic controller. The electric isolator is also connected in a wired manner to the electro-pneumatic controller. As such, the valve has a first connection directly to the controller, and a second connection to the controller through the electric isolator. The electric isolator provides power to both the valve and the controller from a three-pronged AC power supply, and causes feedback current signals from the valve to be delivered to the controller over a resistance. As both the valve and the controller are powered by a same power supply, the use of the electric isolator minimizes the occurrence of ground loops.

The controller determines a voltage differential between two electrical input connections from the valve, i.e., between a first wired connection at which a feedback current signal is directly received from the valve, and a second wired connection at which the feedback current signal is received from the valve over the resistance associated with the electric isolator. The controller then uses the voltage differential to calculate a position of the actuator of the valve, compares the calculated position to a desired set-point or control signal, and utilizes a position control process to generate a drive value based on (e.g., a difference between) the calculated position and the control signal. This drive value corresponds to a pressure to be provided to the pneumatic actuator to achieve a desired operation of the control device (e.g., a desired position of a valve) coupled to the pneumatic actuator.

### SUMMARY

In accordance with a first aspect, a method comprises converting a motion of an actuator of a valve into a value indicative of a position of the actuator, with the converting performed by a wireless position transducer, and with the wireless position transducer being operatively coupled to the valve. The method includes populating a field of a signal with the value indicative of the position of the actuator, with the populating being performed by the wireless position transducer, and causing the signal to be wirelessly transmitted to an electro-pneumatic controller of the valve, with the signal being wirelessly transmitted by the wireless position transmitter. The electro-pneumatic controller of the valve determines a position of the actuator based exclusively on the populated value included in the signal, and the electro-pneumatic controller of the valve controlling the valve based on the determined position of the actuator.

In accordance with a second aspect, a position transducer for use in a process control system comprises a position sensor to detect a position of an actuator coupled to a control device. The control device is used or arranged for use in controlling a process operating in the process control system. A communication interface is arranged to transmit a wireless signal indicative of the position of the actuator, with the communication interface operatively coupled to a wireless communication channel, with the wireless communication channel forming an exclusive connection between the position transducer and a controller of the control device. A rechargeable energy storage device is provided and arranged to power the communication interface.

In accordance with a third aspect, a valve controller comprises a first input to receive a control signal corresponding to a valve, and a second input to receive a wireless position signal from a wireless position transducer via a wireless communication channel, with the wireless position signal being indicative of a position of an actuator of the valve. An output transmits a drive signal to control the actuator of the valve, the drive signal determined by the valve controller based on the control signal and the wireless position signal. The wireless communication channel is an exclusive connection between the wireless position transducer and the valve controller.

In further accordance with any one or more of the foregoing first, second, or third aspects, a method of generating a wireless position signal, a position transducer, and/or a valve controller may further include any one or more of the following preferred forms, in any desired combination.

In one preferred form, the method may include powering the wireless position transducer by a energy storage device included in or proximate to the wireless position transducer.

In another preferred form, the method may include recharging the energy storage device by using at least one of solar energy, a temporary connection of the energy storage device to a an energy source, recovered energy from a local vibration or movement, or induction from a proximity charger.

In a further preferred form, the method may include causing the signal to be wirelessly transmitted comprises causing the signal to be wirelessly transmitted over a wireless communication channel, wherein the wireless communication channel is an exclusive connection between the wireless position transducer and the electro-pneumatic controller.

In another preferred form, the method may include causing the signal to be wirelessly transmitted comprises causing the signal to be wirelessly transmitted using a HART wireless protocol over a wireless mesh communications network.

In a further preferred form, the method may include causing the signal to be wirelessly transmitted using a wireless communication network to a control host of a process plant, the process plant including the valve and the electro-pneumatic controller.

In another preferred form, the wireless signal may be transmitted to at least one of the controller of the control device or a control system host or the process control system.

In another preferred form, a value of a field included in the wireless signal is indicative of the position of the actuator, and a recipient of the wireless signal determines the position of the actuator based exclusively on the value of the field included in the wireless signal.

In a further preferred form, the wireless signal is accordance with a wireless HART protocol, and/or the wireless communication channel is included in a private wireless mesh communication network of the process control system.

In another preferred form, the wireless signal is transmitted according to a schedule defined by a network manager of the wireless mesh communication network.

In a further preferred form, the position sensor includes at least one of a potentiometer, a magnetic sensor, a piezo-electric transducer, a hall effect sensor, or a string potentiometer.

In another preferred form, the control device is a valve.

In a further preferred form, the control signal may be in accordance with a wireless HART protocol, the wireless position signal may be in accordance with the wireless HART protocol, the first input may be communicatively connected to a wireless mesh network and the control signal is received according to a schedule generated by a network manager of the wireless mesh network, and/or the second input may communicatively connected to the wireless mesh network and the wireless position signal is received according to the schedule generated by the network manager of the wireless mesh network.

In another preferred form, the wireless position signal is in accordance with a wireless HART protocol.

In still another preferred form, the wireless communication channel is included in a wireless mesh network, and wherein the wireless position signal is received according to a network schedule generated by a network manager of the wireless mesh network.

In still another preferred form, the valve controller determines the drive signal based on a value of a field included in the wireless position signal.

In still another preferred form, the wireless position transducer is located in a different environment than the controller.

### BRIEF DESCRIPTION OF THE DRAWINGS

FIG. 1 is a block diagram of an example process control system including a wireless position transducer that is in wireless communication with a controller of a control device;

FIG. 2 is a detailed block diagram of the wireless position transducer and the controller of FIG. 1;

FIG. 3 is a block diagram that illustrates an example process control system utilizing a wireless communication network to provide wireless communication between control devices, controllers, routers, and other network devices; and

FIG. 4 is an example method of providing a wireless position signal to a controller.

### DETAILED DESCRIPTION

Although the following describes example methods and apparatus including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the following describes example methods and apparatus, the examples provided are not the only way to implement such methods and apparatus.

Typically, in a process control system, a controller (e.g., an electro-pneumatic controller) is directly coupled to a control device (e.g., a control valve, a pump, a damper, etc.). A position sensor coupled to the control device measures the movement of an actuator coupled to the control device, and provides a resistive output that indicates the travel or the position of the actuator to a controller of the control device. The controller calculates a position of the actuator based on a voltage differential across the resistive output, compares the position with a desired control signal or setpoint, and outputs a signal to control the control device based on the comparison.

In some applications, however, the wires over which the position indications are transmitted are noisy. This electrical noise may compromise the output of the sensor to the extent such that, in some cases, the control device may move even though it was not commanded to do so. That is, the noise on the wires may cause false values to be received at the controller of the control device. Accordingly, with the false values, the process which is being controlled by the control device may itself become uncontrolled.

In other applications, wiring connections between a position sensor and a controller is extremely costly and difficult, if not impossible, due to environmental conditions such as inaccessibility, temperature, humidity, radiation, vibrations, and the like.

Embodiments of the apparatus and the methods disclosed herein provide a manner in which a position transducer of a control device may be communicatively and wirelessly coupled to a controller. The wireless coupling of the controller to the position transducer enables the controller to wirelessly receive a position indication signal from the position transducer, so that false signals due to noisy wires and adverse environmental conditions are mitigated. Additionally, the example methods and apparatus described herein provide the flexibility to install and locate the controller in a different operating environment than the position transducer. As such, performance of the process control system may increase, and installation costs of the process control system may decrease.

While the disclosed methods and apparatus are described below in conjunction with examples involving an electro-pneumatic digital valve controller and a pneumatically actuated valve, the disclosed methods and apparatus may be implemented with other types of controllers, with valves actuated in other manners, and/or with process control devices other than valves.

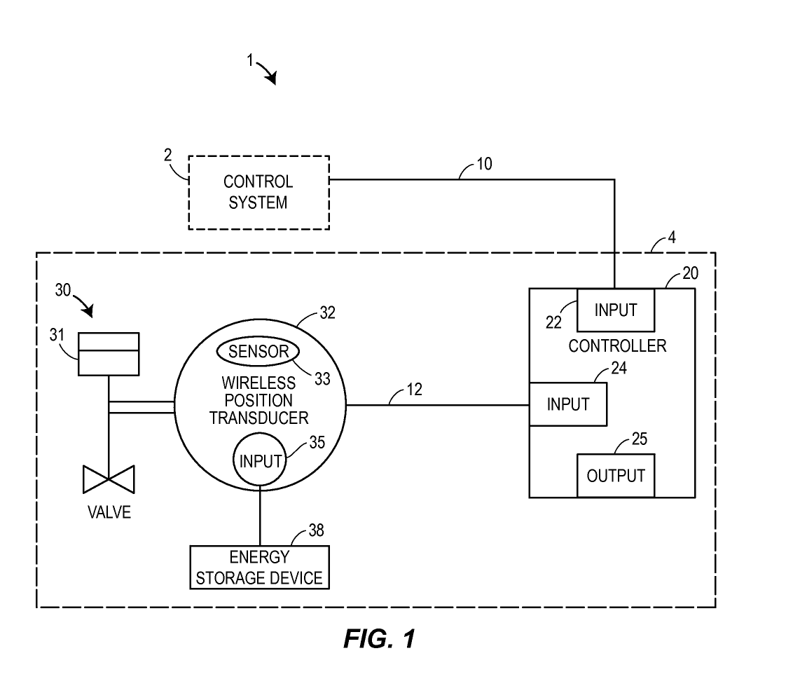

FIG. 1 is a diagram of a process control system 1 including a control system 2 and a process control area 4. The process control system 1 may be included in a process plant, such as a petroleum, chemical and/or other type of industrial process plant, and the process control system 1 may control one or more processes executed by the process plant. The control system 2 may include workstations, controllers, marshalling cabinets, input/output cards, and/or any other type of process control system management components (not shown in FIG. 1). Typically, the control system 2 is located in a different area than the process control area 4 such as an enclosed room, e.g., to shield the control system 2 from noise, dust, heat, and other undesired environmental conditions. The control system 2 may be in communicative connection with an electro-pneumatic controller 12 located in the process control area 4. The control system 2 may power the electro-pneumatic controller 20, or the electro-pneumatic controller 20 may be powered by a local energy source, such as an external voltage source, solar power, battery power, a capacitor, etc.

The electro-pneumatic controller 20 includes a communication interface 22 via which signals from the control system 2 and/or to the control system 2 may be received and sent over one or more communication channels 10. The one or more communication channels 10 may include a wired communication channel, a wireless communications channel, or both a wired and a wireless communication channel. Accordingly, the interface 22 may be a wired interface, a wireless interface, or both a wired and a wireless interface. The interface 22 may be configured to communicate with a control host, other controllers, and/or other elements included in the control system 2. In an embodiment, the interface 22 is configured to communicate with other controllers and/or elements included in the process control area 4.

In an embodiment, the interface 22 may receive, from the control system 2, control signals over the channel(s) 10 that specify or correspond to a valve state for a valve 30 that is located in the process control area 4. For example, the control signals received by the electro-pneumatic controller 20 using the interface 22 may cause a pneumatic actuator 31 coupled to the valve 30 to be open, closed, or moved to some intermediate position.

The control signals (e.g., input signals) received at the interface 22 may include, for example, a 4-20 mA signal, a 0-10 VDC signal, a wireless signal, and/or digital commands, etc. For example, in a case where the control signal is a 4-20 mA signal, a digital data communication protocol such as, for example, the well-known Highway Addressable Remote Transducer (HART) protocol may be used to communicate over a wired connection 10 with the electro-pneumatic controller 20. In another example, the control signal may be a wireless control signal received over a wireless communication channel 10 using a wireless HART protocol. In other examples, the control signal may be a 0-10 VDC signal, or other type of signal. Such digital communications may be used by the control system 2 to retrieve identification information, operation status information and diagnostic information from the electro-pneumatic controller 20. Additionally or alternatively, such digital communications may be used by the control system 2 to effect control of the valve 30 through its respective controller 20.

The example electro-pneumatic controller 20 of FIG. 1 may control the position of the actuator 31 and, thus, the position of the valve 30. The electro-pneumatic controller 20 may include, although not shown, a control unit, a current-to-pneumatic (I/P) converter, and a pneumatic relay. In other examples, the electro-pneumatic controller 20 may include any other components for controlling and/or providing pressure to the valve actuator 31. Additionally, the electro-pneumatic controller 20 may include other signal processing components such as, for example, analog-to-digital converters, filters (e.g., low-pass filters, high-pass filters, and digital filters), amplifiers, etc. For example, the control signal received from the control system 2 may be filtered (e.g., using a low/high pass filter) prior to being processed by a control unit within the electro-pneumatic controller 20.

More specifically, the electro-pneumatic controller 20 may control the position of the actuator 31 by comparing a wireless feedback or position signal generated by a wireless position transducer 32 to the control signal originating from the control system 2. The wireless feedback signal generated by the wireless position transducer 32 may be, for example, in accordance with the wireless HART protocol or some other suitable wireless protocol, and may be transmitted from the transducer 32 to the controller 20 over one or more wireless communications channels 12.

The wireless feedback signal generated by the wireless position transducer 32 may be received by the electro-pneumatic controller 20 at a second communication interface 24, coupled to the wireless channel(s) 12. The interface 24 may include includes a wireless transceiver, or a wireless receiver. The electro-pneumatic controller 20 may determine the feedback signal based on the wireless feedback or position signal received from the wireless position transducer 32 via the second interface 24. In an embodiment, the first interface 22 and the second interface 24 may be integrated into a single wireless interface.

The control signal provided by the control system 2 may be used by the electro-pneumatic controller 20 as a set-point or reference signal corresponding to a desired operation (e.g., a desired position corresponding to a percentage of a control valve 30 operating span) of the valve 30. The control unit (not shown) within the electro-pneumatic controller 20 may compare the wireless feedback signal to the control signal by using the control signal and the wireless feedback signal as values in a position control algorithm or process to determine a drive value. The position control process performed by the control unit may determine (e.g., calculates) the drive value based on the difference between the feedback signal and the control signal. This calculated difference corresponds to an amount the electro-pneumatic controller 20 is to change the position of the actuator 31 coupled to the valve 30, in an embodiment. The calculated drive value also corresponds to a current generated by the control unit to cause an I/P converter within the electro-pneumatic controller 20 to generate a pneumatic pressure, in an embodiment. The electro-pneumatic controller 20 outputs the drive signal via an output 25 to control the valve 30, for example.

In an embodiment, the I/P converter within the electro-pneumatic controller 20 is included in the output 25. The I/P converter may be a current-to-pressure type transducer that generates a magnetic field based on the current applied through the solenoid. The solenoid may magnetically control a flapper that operates relative to a nozzle to vary a flow restriction through the nozzle/flapper to provide a pneumatic pressure that varies based on the average current through the solenoid. This pneumatic pressure may be amplified by a pneumatic relay and applied to the actuator 31 coupled to the valve 30. The pneumatic relay within the electro-pneumatic controller 20 may be pneumatically coupled to the actuator 31 to provide the actuator 31 with a pneumatic pressure (not shown).

For example, a drive value that increases the current generated by the control unit within the electro-pneumatic controller 20 may cause the pneumatic relay to increase a pneumatic pressure applied to the pneumatic actuator 31 to cause the actuator 31 to position the valve 30 towards a closed position. Similarly, drive values that decrease the current generated by the control unit may cause the pneumatic relay to decrease the pneumatic pressure applied to the pneumatic actuator 31 to cause the actuator 31 to position the valve 30 towards an open position.

In other examples, the output 25 of the electro-pneumatic controller 20 may include a voltage-to-pressure type of transducer, in which case the drive signal is a voltage that varies to provide a varying pressure output to control the valve 30. Additionally, other examples of outputs may implement other types of pressurized fluid including pressurized air, hydraulic fluid, etc.

Turning to the example valve 30 of FIG. 1, the valve 30 may include a valve seat defining an orifice that provides a fluid flow passageway between an inlet and an outlet, in an embodiment. The valve 30 may be, for example, a rotary valve, a quarter-turn valve, a motor-operated valve, a damper, or any other control device or apparatus. The pneumatic actuator 31 coupled to the valve 30 may be operatively coupled to a flow control member via a valve stem, which moves the flow control member in a first direction (e.g., away from the valve seat) to allow fluid flow between the inlet and the outlet and in a second direction (e.g., toward the valve seat) to restrict or prevent fluid flow between the inlet and the outlet.

The actuator 31 coupled to the example valve 30 may include a double-acting piston actuator, a single-acting spring return diaphragm or piston actuator, or any other suitable actuator or process control device. To control the flow rate through the valve 30, the valve is coupled to the wireless position transducer 32. In an embodiment, the wireless position transducer 32 includes a sensor 33 to sense the position of the actuator 31 coupled to the valve 30, such as a position sensor and/or a pressure sensor that may include, for example, a potentiometer and/or a magnetic sensor. The sensor 33 may include a potentiometer, a magnetic sensor, a piezo-electric transducer, a Hall effect sensor, a string potentiometer, etc. The terms “sensor” and “position sensor” are used interchangeably herein.

The sensor 33 of the wireless position transducer 32 may detect the position of the actuator 31 and, thus, the position of the flow control member relative to the valve seat (e.g., an open position, a closed position, an intermediate position, etc.). In an embodiment, the sensor 33 allows the wireless position transducer 32 to convert a linear motion of the actuator 31 corresponding to a position of the actuator 31 into a wireless feedback signal. In an embodiment, the sensor 33 allows the wireless position transducer 32 to convert a position of the actuator 31 into a wireless feedback signal. The wireless position transducer 32 may be configured to cause the wireless feedback signal to be transmitted to the electro-pneumatic controller 20. The wireless feedback signal may represent a position of the actuator 31 coupled to the valve 30 and, thus, a position of the valve 30. The example techniques, methods and apparatus described herein enable the electro-pneumatic controller 20 to receive a feedback signal from any type of example wireless position transducer 32 of FIG. 1 that can be coupled to the valve 30.

Generally, the position sensor 33 of the wireless position transducer 32 is not substantially affected by adverse environmental conditions. The wireless position transducer 32 may include electro-magnetic suppression circuitry, noise filtering circuitry, vibration immunity components, and/or radiation shielding components to further isolate or protect the position sensor 33 from adverse environmental conditions.

The wireless position transducer 32 may include an input or connection 35 that receives power from a local power source or energy storage device 38. In an embodiment, the local power source or energy storage device 38 is included with the wireless position transducer 32 as an integral unit. In an embodiment, the local power source or energy storage device 38 is rechargeable. For example, the local power source or energy storage device 38 may be a battery, capacitor, or other rechargeable energy storage device. Any known technique for recharging the local power source or energy storage device 38 may be used, such as capturing solar energy; replacing a battery; recovering energy from local heat, vibration and/or movement; temporarily connecting to a plug-in source such as a AC power source; inductively recharging using a proximity charger; or other suitable recharging technique.

While the electro-pneumatic controller 20 and the wireless position transducer 32 in FIG. 1 are shown as being located within the process control area 4, each of the electro-pneumatic controller 20 and the wireless position transducer 32 may be located in a respective different operating environment and communicatively coupled together via one or more wireless communication channels, such as via wireless communication channels included in a wireless communication network of the process plant or control environment 1. For example, the wireless position transducer 32 may be located within a relatively high temperature and high humidity environment (e.g., 90% humidity and 180 degrees Fahrenheit (° F.)) while the electro-pneumatic controller 20 is located in a controlled environment set to 10% humidity and 72° F.

Additionally, the wireless communication channel 12 is an exclusive connection between the wireless position transducer 32 and the controller 20, in an embodiment. In particular, no wires connect the wireless position transducer 32 and the controller 20. As such, the wireless position transducer 32 does not require any other connections (other than the wireless communication channel 12) to receive power or to communicate with the controller 20. Indeed, with the techniques of the present disclosure, an electric isolator is not needed to provide power to the wireless position transducer 32. Rather, as the wireless position transducer 32 is powered by a local source 38 (which, in some embodiments, is included in the wireless position transducer 32 itself), cumbersome wires need not be routed to the transducer 32 (and need not be maintained) in order to power the transducer 32. Furthermore, as the transducer 32 and the controller 20 are powered by different, separate and distinct power sources, the need for an electric isolator to minimize ground loops is moot.

Still further, with the techniques of the present disclosure, an electric isolator is also not needed to apply feedback current signals generated by the transducer 32 across a resistance in order for the controller 20 to calculate a position of the actuator 31 of the transducer 32. In particular, instead of requiring two inputs at the controller 20 to determine a voltage differential, and requiring that the controller 20 calculate the position of the actuator 31 based on the determined voltage differential, the controller 20 merely receives the signal (e.g., a packet) from the wireless position transducer 32 at an input 24 coupled to the wireless channel 12. From the wireless signal, the controller 20 extracts a populated value from a field in the signal, where the populated value is indicative of the position of the actuator 31. In an embodiment, the populated value from the wireless signal is the only input or value received from the wireless position transducer 32 that is used by the controller 20 to determine the position of the actuator 31; a second input or value from the wireless position transducer 32 is not needed. Accordingly, with the techniques of the present disclosure, not only are the electric isolator and the wires connecting the isolator, the valve and the controller not needed, but the additional hardware, processing time and memory required for the controller to calculate a position of the actuator 31 is also not required.

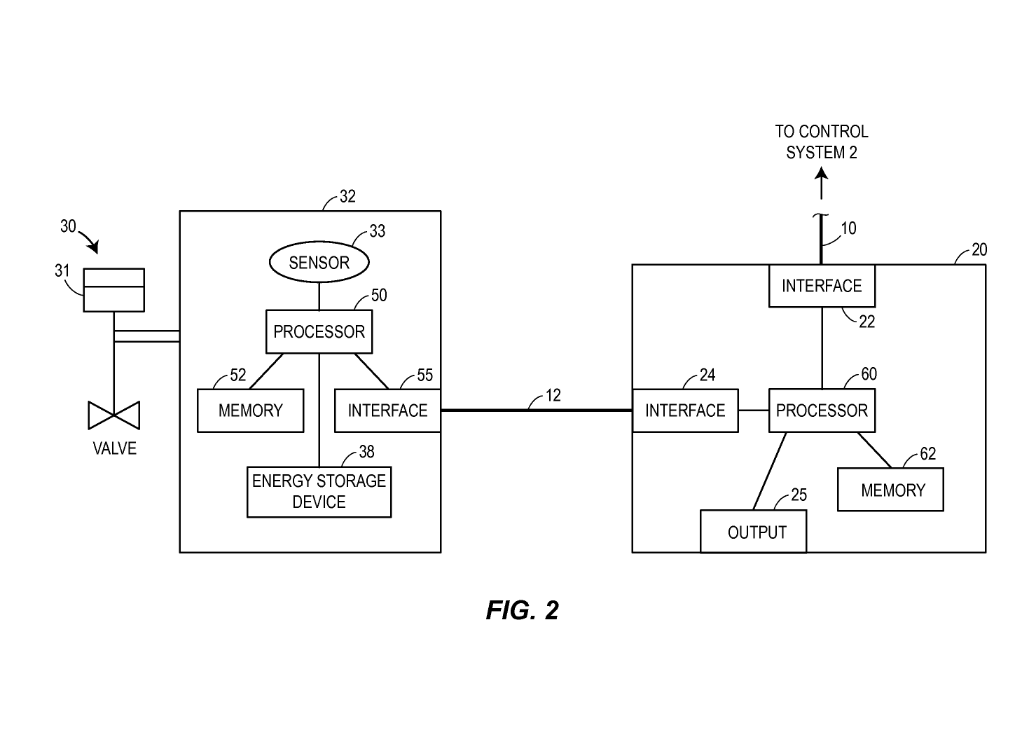

A detailed block diagram of the wireless position transducer 32 is shown in FIG. 2. As previously discussed, the wireless position transducer 32 may include a position sensor 33 coupled to the actuator 31 of the valve 30. The wireless position transducer 32 may further include a processor 50 coupled to the sensor 33 and to a memory 52. The memory 52 may be a tangible, non-transitory memory, and may include one or more computer-readable storage media. For example, the memory 52 may be implemented as one or more semiconductor memories, magnetically readable memories, optically readable memories, and/or any other suitable tangible, non-transitory computer-readable storage media. The memory 52 may store computer-executable instructions that are executable by the processor 50 to convert the output of the sensor 33 into a value that is indicative of the position of the actuator 31 of the valve 30, and to populate the value into a field of a wireless position signal. The computer-executable instructions may be further executable to cause the wireless position signal to be transmitted from the transducer 32 via a wireless interface 55. The wireless interface 55 may be communicatively coupled to one or more wireless communication channels 12, and the wireless interface 55 may include a transceiver, or may include a transmitter and a receiver.

In an embodiment, the wireless position signal is a packet in accordance with the wireless HART protocol, the wireless communication channels 12 are included in a wireless mesh communication network of the process control system 1, and the packet is transmitted and received over the wireless communication channel 12 according to a schedule generated by a network manager of the wireless mesh communication network. For example, the network manager may generate a network communications schedule (e.g., “network schedule”) defining transmission slots for packets generated by the wireless position transducer 32, so that the packets are received at the controller 20 to accurately and safely control the valve 30 and the process of which the valve 30 is a part. In an embodiment, one or more portions of the schedule pertaining to the wireless mesh transducer 32 may be delivered to the transducer 32 (e.g., from the network manager via the wireless communication network) and stored in the memory 52, so that the processor 50 may cause packets or signals to be transmitted to the controller 20 in accordance with the stored schedule.

The wireless position signal may be transmitted via the wireless interface 55 to the electro-pneumatic controller 20 to control the valve 30. In an embodiment, the wireless position signal may be additionally or alternatively transmitted via the wireless interface 55 to the control system 2 for position monitoring or other purposes. For example, the wireless position signal may be transmitted to a control system host of the control system 2. The wireless position signal may be transmitted to the control system 2 either directly or via one or more intermediate nodes included in a wireless communication network of the process control plant or system 1. In an embodiment, the processor may cause packets or signals to be transmitted to the control system 2 in accordance with a schedule stored in the memory 55, where the schedule is generated by a network manager of a wireless communication network coupled to the wireless interface 55.

FIG. 2 also includes a detailed block diagram of the electro-pneumatic controller 20 of FIG. 1. As previously discussed, the controller 20 includes a first input or interface 22 to receive a control signal from the control system 2, and a second input or interface 24 to receive the wireless position signal from the wireless position transducer 32. The wireless interface 24 may be communicatively coupled to one or more wireless communication channels 12 over which the wireless position signal generated by the wireless position transducer 32 is received. The wireless interface 24 may include a transceiver, or may include a transmitter and a receiver.

The first interface 22 may be a wired interface, a wireless interface, or a wired and a wireless interface coupled to one or more communication channels 10. In embodiments in which the first interface 22 includes a wireless interface, the first interface 22 and the second interface 24 may be a single integrated wireless interface. In an embodiment, the one or more communication channels 10 and/or the one or more communication channels 12 are included a wireless mesh communication network of the process plant or system 1.

The electro-pneumatic controller 20 further includes a control unit or processor 60 coupled to a memory 62, to the inputs 22, 24, and to the output 25. The memory 62 may be a tangible, non-transitory memory, and may include one or more computer-readable storage media. For example, the memory 62 may be implemented as one or more semiconductor memories, magnetically readable memories, optically readable memories, and/or any other suitable tangible, non-transitory computer-readable storage media. The memory 62 may store computer-executable instructions that are executable by the processor 60 to determine, based on the received wireless position signal from the second interface 24 and the received control signal from the first interface 22, a value of a drive signal to be transmitted via the output 25 to control the valve 30. For example, the computer-executable instructions to determine the drive signal comprise a position control algorithm or process that is downloaded during configuration and/or during real-time from the control system 2.

In an embodiment, the wireless position signal is a packet in accordance with the wireless HART protocol, the wireless communication channels 12 are included in a wireless mesh communication network of the process control system 1, and the packet is transmitted and received over the wireless communication channel 12 according to a schedule generated by a network manager of the wireless mesh communication network. For example, the network manager may generate a network schedule defining reception slots for packets that are received at the controller 20 from the wireless position transducer 32 to accurately and safely control the valve 30 and the process of which the valve 30 is a part. In an embodiment, one or more portions of the schedule pertaining to the controller 20 may be delivered to the controller 20 (e.g., from the network manager via the wireless communication network) and stored in the memory 62, so that the controller 20 receives packets or signals from the wireless position transducer 32 in accordance with the stored schedule.

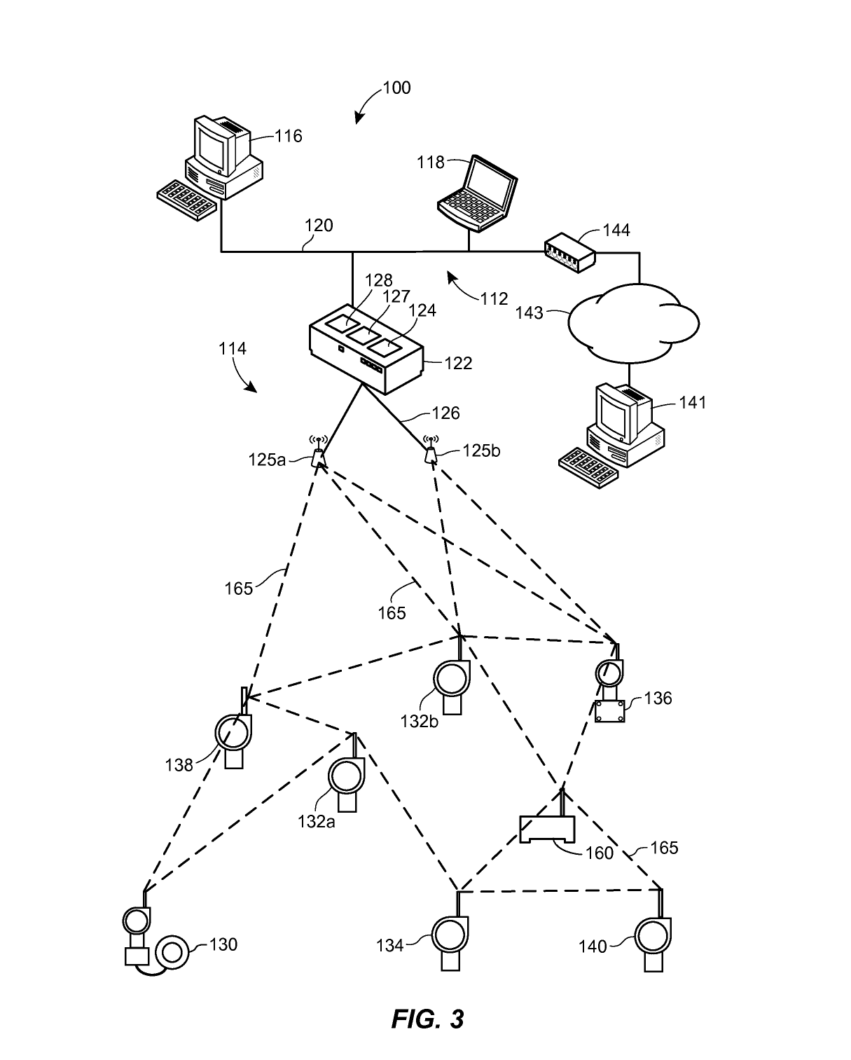

FIG. 3 illustrates an exemplary process control network 100 into which the wireless position transducer 32 may be incorporated. In an embodiment, the process control network 100 is included in the control system 1 of FIG. 1. In particular, the network 100 may include a plant automation network 112 and a communications network 114. In the embodiment of the process control network 100 shown in FIG. 1, the communications network 114 is illustrated as a wireless mesh communications network. In an embodiment, the communications network 114 supports a wireless HART (Highway Addressable Remote Transducer) protocol, e.g., a “wireless HART network.” In some embodiments of the network 100, however, the communications network 114 may support a wired HART protocol, e.g., a “wired HART network.” In some embodiments, both a wired and a wireless HART network 114 may be included in the network 100.

The plant automation network 112 may include one or more stationary workstations 116 and one or more portable workstations 118 connected over a communication backbone 120. The workstations 116, 118 are interchangeably referred to herein as “workstations,” “control system hosts,” “control hosts,” or “hosts” of the process control network 100. The backbone 120 may be implemented over Ethernet, RS-485, Profibus DP or other suitable communication protocol.

The plant automation network 112 and the wireless HART network 114 may be connected via a gateway 122. Specifically, the gateway 122 may be connected to the backbone 120 in a wired manner and may communicate with the plant automation network 112 by using any suitable known protocol. The gateway 122 may be implemented as a standalone device, as a card insertable into an expansion slot of the hosts or workstations 116 or 118, or as part of the IO subsystem of a PLC-based or DCS-based system, or in any other manner. The gateway 122 may provide, to applications running on the network 112, access to various network devices of the wireless HART network 114. In addition to protocol and command conversion, the gateway 122 may provide synchronized clocking used by time slots and superframes (sets of communication time slots spaced equally in time) of the scheduling scheme of the wireless HART network 114.

In some situations, networks may have more than one gateway 122. These multiple gateways can be used to improve the effective throughput and reliability of the network by providing additional bandwidth for the communication between the wireless HART network and the plant automation network 112 or the outside world. On the other hand, the gateway 122 device may request bandwidth from the appropriate network service according to the gateway communication needs within the wireless HART network. The gateway 122 may further reassess the necessary bandwidth while the system is operational. For example, the gateway 122 may receive a request from a host residing outside the wireless HART network 114 to retrieve a large amount of data. The gateway device 122 may then request additional bandwidth from a dedicated service such as a network manager in order to accommodate this transaction. The gateway 122 may then request the release of the unnecessary bandwidth upon completion of the transaction.

In some embodiments, the gateway 122 is functionally divided into a virtual gateway 124 and one or more network access points 125a, 125b. Network access points 125a, 125b may be separate physical devices in wired communication with the gateway 122 in order to increase the bandwidth and the overall reliability of the wireless HART network 114. However, while FIG. 1 illustrates a wired connection 26 between the physically separate gateway 122 and access points 125a, 125b, it will be understood that the elements 122-126 may also be provided as an integral device. Because network access points 125a, 125b may be physically separate from the gateway device 122, each of the access points 125a, 125b may be strategically placed in several distinct locations. In addition to increasing the bandwidth, the multiple access points 125a, 125b can increase the overall reliability of the network by compensating for a potentially poor signal quality at one access point at one or more other access points. Having multiple access points 125a, 125b also provides redundancy in case of failure at one or more of the access points 125a, 125b.

The gateway device 122 may additionally contain a network manager software module 127 (e.g., “network manager”) and a security manager software module 128 (e.g., “security manager”). In another embodiment, the network manager 127 and/or the security manager 128 may run on one of the process control hosts 116, 118 of the plant automation network 112. For example, the network manager 127 may run on the host 116 and the security manager 128 may run on the host 118. The network manager 127 may be responsible for configuration of the network 114; scheduling communications between devices included in the network 114 such as wireless HART devices (i.e., configuring superframes); determining a network communication schedule and cause at least portions thereof to be delivered to recipient devices and controllers; managing routing tables; and monitoring and reporting the health of the wireless HART network 114. While redundant network managers 27 are supported, it is contemplated that there should be only one active network manager 127 per wireless HART network 114. In one possible embodiment, the network manager 127 analyzes the information regarding the layout of the network, the capability and update rate of each network device, and other relevant information. The network manager 127 may then define routes and schedules of communications to, from and between network devices in view of these factors. In an embodiment, the network manager 127 may be included in one of the control hosts 116, 118.

Referring again to FIG. 1, the wireless HART network 114 may include one or more field devices or control devices 130-140. In general, process control systems, like those used in chemical, petroleum or other process plants, include such field devices as valves, valve positioners, switches, sensors (e.g., temperature, pressure and flow rate sensors), pumps, fans, etc. Field devices may perform process control functions within a process that is controlled by the process control network 100. A process control function may include, for example, opening or closing valves and/or monitoring or taking measurements of process parameters. In the wireless HART communication network 114, field devices 130-140 are producers and consumers of wireless HART packets.

An external host 141 may be connected to an external network 143 which, in turn, may be connected to the plant automation network 112 via a router 144. The external network 143 may be, for example, the World Wide Web (WWW). Although the external host 141 does not belong to either the plant automation network 112 or the wireless HART network 114, the external host 141 may access devices on both networks 112, 114 via the router 144. Accordingly, the communication network 114 and the plant automation network 112 of the process control system 100 may be private networks, so that access to the networks 112, 114 is secured. For example, devices wishing to connect to the network 112 and/or the network 114 may be required to be authorized. Similarly, the external host 141 may control secure network access for communications from the external network 143.

The wireless HART network 114 may use a protocol which provides similar operational performance that is experienced with wired HART devices. The applications of this protocol may include process data monitoring, critical data monitoring (with the more stringent performance requirements), calibration, device status and diagnostic monitoring, field device troubleshooting, commissioning, and supervisory process control. These applications require that the wireless HART network 114 use a protocol which can provide fast updates when necessary, move large amounts of data when required, and support network devices which join the wireless HART network 114 only temporarily for commissioning and maintenance work.

In one embodiment, the wireless protocol supporting network devices of the wireless HART network 114 is an extension of HART, a widely accepted industry standard that maintains the simple workflow and practices of the wired environment. The wireless HART protocol may be used to establish a wireless communication standard for process applications and may further extend the application of HART communications and the benefits it provides to industry by enhancing the HART technology to support wireless process automation applications.

Referring again to FIG. 3, field or control devices 130-136 may be wireless HART devices. In other words, a field device 130, 132a, 132b, 134, or 136 may be provided as an integral unit supporting all layers of the wireless HART protocol stack. In the network 100, the field device 130 may be a wireless HART flow meter, the field device 132b may be wireless HART pressure sensors, and the field device 136 may a wireless HART pressure sensor.

In particular, the field device 134 may be a valve or a valve positioner including a wireless position transducer (such as the wireless position transducer 32 of FIG. 1), and the field device 132a may be a controller (such as the controller 20 of FIG. 1) that receives position indications from the field device 134. In an embodiment, the control host 116 and/or the control host 118 each receives at least some of the position indications from the field device 134, such as via the wireless mesh communication network 114, the gateway 122, and the plant automation network 120.

Additionally, the wireless HART network 114 may include a router device 160. The router device 160 may be a network device that forwards packets from one network device to another. A network device that is acting as a router device may use internal routing tables to decide to which network device it should forward a particular packet. Stand alone routers such as the router 160 may not be required in those embodiments where all devices on the wireless HART network 114 support routing. However, it may be beneficial (e.g. to extend the network, or to save the power of a field device in the network) to add a dedicated router 160 to the network.

All devices directly connected to the wireless HART network 114 may be referred to as network devices. In particular, the wireless HART field or control devices 130-136, the routers 60, the gateway 122, and the access points 125a, 125b are, for the purposes of routing and scheduling, the network devices or the nodes of the wireless HART network 114. In order to provide a very robust and an easily expandable network, it is contemplated that all network devices may support routing and each network device may be globally identified by its HART address. Additionally, each network device may store information related to update rates, connections sessions, and device resources. In short, each network device maintains up-to-date information related to routing and scheduling. The network manager 127 communicates this information to network devices upon initialization or re-initialization of the network devices, whenever new devices join the network, or whenever the network manager detects or originates a change in topology or scheduling of the wireless HART network 114.

Referring again to FIG. 3, in a pair of network devices connected by a direct wireless connection 165, each device recognizes the other as a neighbor. Thus, network devices of the wireless HART network 114 may form a large number of connections 165. The possibility and desirability of establishing a direct wireless connection 165 between two network devices is determined by several factors such as the physical distance between the nodes, obstacles between the nodes, signal strength at each of the two nodes, etc. Further, two or more direct wireless connections 165 may form paths between nodes that cannot form a direct wireless connection 165. For example, the direct wireless connection 165 between the wireless HART hand-held device 155 and wireless HART device 136 along with the second direct wireless connection 165 between the wireless HART device 136 the router 160 form a communication path between devices 155 and 160.

Each wireless connection 165 is characterized by a large set of parameters related to the frequency of transmission, the method of access to the radio resource, etc. One of ordinary skill in the art will recognize that, in general, wireless communication protocols may operate on designated frequencies, such as the ones assigned by the Federal Communications Commission (FCC) in the United States, or in the unlicensed part of the radio spectrum (2.4 GHz). While the system and method discussed herein may be applied to a wireless network operating on any designated frequency or range of frequencies, the embodiment discussed below relates to the wireless HART network 114 operating in the unlicensed or shared part of the radio spectrum. In accordance with this embodiment, the wireless HART network 114 may be easily activated and adjusted to operate in a particular unlicensed frequency range as needed.

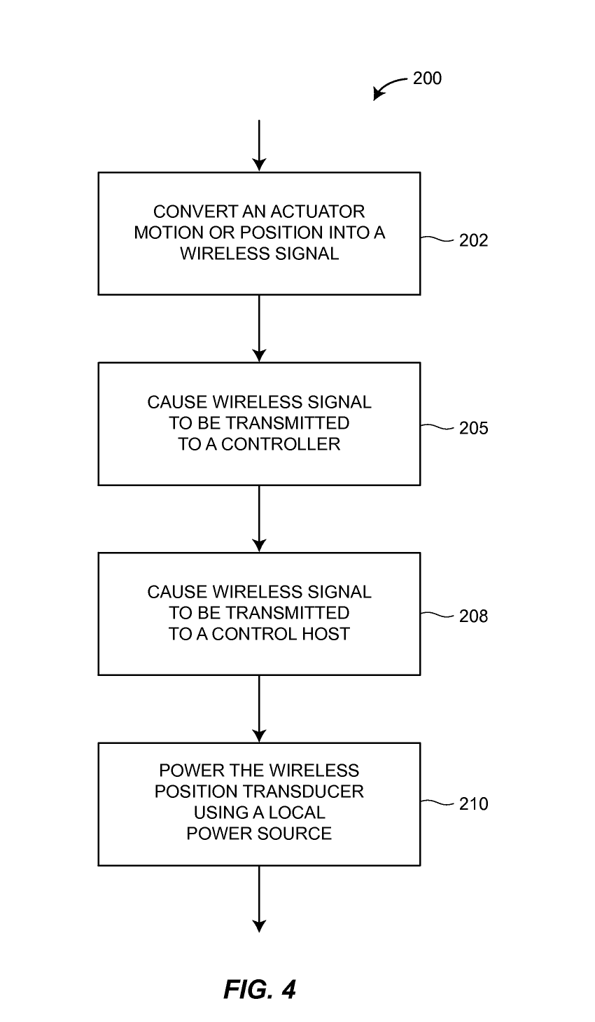

FIG. 4 is a flowchart of an example method 200 of providing a wireless position signal to a controller of a control device. The method 200 may operate in conjunction with the example electro-pneumatic controller 20, the example wireless position transducer 32, the example configurations shown in FIGS. 1, 2 and/or 3, and/or with other suitable controllers, control devices, and/or configurations. In an embodiment, one or more portions of the method 200 are performed by the wireless position transducer 32.

The method 200 may be implemented using any combination of any of the foregoing techniques such as, for example, any combination of firmware, software, discrete logic and/or hardware. Further, many other methods of implementing the example operations of FIG. 4 may be employed. For example, the order of execution of the blocks may be changed, and/or one or more of the blocks described may be changed, eliminated, sub-divided, or combined. Additionally, any or all of the method 200 may be carried out sequentially and/or carried out in parallel by, for example, separate processing threads, processors, devices, discrete logic, circuits, etc.

The method 200 includes converting a motion of an actuator of the valve into a signal (block 202). For example, a wireless position transducer 32 is coupled to a valve 30, and the transducer 32 converts the motion of an actuator 31 of the valve 30 into a value that is indicative of the motion or a position of the actuator. The value indicative of the actuator motion or position may be populated into a field of a wireless position signal. In an embodiment, the wireless position signal is in accordance with a wireless HART protocol.

The method 200 also includes causing, by the wireless position transducer, the wireless position signal to be wirelessly transmitted, using a wireless protocol, to an electro-pneumatic controller of the valve to control the valve (block 205). For example, the wireless position transducer 32 causes the wireless position signal to be wirelessly transmitted to an electro-pneumatic controller 20 to control the valve 30. In an embodiment, a the wireless position signal is an only input received from the valve 30 that is required by the controller 20 to control the valve 30. In an embodiment, the wireless position signal is in accordance with a wireless HART communication protocol. In an embodiment, the wireless position signal is transmitted to the electro-pneumatic controller over a communication channel of a wireless mesh communication network, such as according to a schedule generated by a network manager of the wireless mesh communication network. In an embodiment, a wireless communication channel over which the signal is transmitted is an only connection between the wireless position transducer and the controller.

The method 200 may also include causing the signal to be wirelessly transmitted to a control host of a process plant or process control system in which the valve and the electro-pneumatic controller are included (block 208). For example, the wireless position signal may be transmitted to a control system host 116, 118 of a process control system 100. In an embodiment, the wireless position signal is transmitted to the control system host over a wireless mesh communication network in accordance with a schedule generated by a network manager of the wireless mesh communication network.

Some embodiments of the method 200 may include only one of the blocks 205 and 208, and some embodiments of the method 200 may include both blocks 205 and 208.

In an embodiment, the method 200 includes powering the wireless position transducer by a power source (block 210). For example, the wireless position transducer 32 (e.g., the processor 50 and/or the communication interface 55 of the wireless position transducer 32) are powered by the power source. Typically, the power source is a local power source that is physically proximate to the wireless position transducer, such as a direct, local wired connection to a power source, a battery, a capacitor, or other suitable local power source. In some embodiments, the local power source is included in the wireless position transducer as an integral unit.

In some embodiments, the power source is a rechargeable energy storage device, and the method 200 includes recharging the rechargeable energy source using any known recharging technique, such as the capturing and conversion of solar energy, battery replacement, energy recovery of local heat, vibration and/or movement, a temporary connection to a plug-in source such as a DC power source, induction using a proximity charger, or any other suitable recharging means or mechanism.

At least some of the various blocks, operations, and techniques described above may be implemented in hardware, a processor executing firmware and/or software instructions, or any combination thereof. For instance, at least portions of the wireless position transducer 32 may be implemented in hardware, a processor executing firmware and/or software instructions, or any combination thereof. Additionally, at least a portion of the blocks of FIG. 4 may be implemented in hardware, a processor executing firmware and/or software instructions, or any combination thereof.

When implemented utilizing a processor executing software or firmware instructions, the software or firmware instructions may be stored in any non-transitory, tangible computer readable storage medium such as a magnetic disk, an optical disk, a RAM or ROM or flash memory, tape drive, etc. The software or firmware instructions may include machine readable instructions stored on a memory or other non-transitory computer-readable storage medium that, when executed by the processor, cause the processor to perform various acts.

When implemented in hardware, the hardware may comprise one or more of discrete components, an integrated circuit, an application-specific integrated circuit (ASIC), a programmable logic device, etc.

Although the forgoing text sets forth a detailed description of numerous different embodiments, it should be understood that the scope of the patent is defined by the words of the claims set forth at the end of this patent and their equivalents. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

What is claimed:

1. A method, comprising:
converting a motion of an actuator of a valve into a value indicative of a position of the actuator,
the converting performed by a wireless position transducer, and
the wireless position transducer coupled to the valve;
populating a field of a signal with the value indicative of the position of the actuator,
the populating performed by the wireless position transducer; and
causing the signal to be wirelessly transmitted to an electro-pneumatic controller of the valve,
the causing the signal to be wirelessly transmitted performed by the wireless position transmitter,
the electro-pneumatic controller of the valve determining a position of the actuator exclusively based on the populated value included in the signal, and
the electro-pneumatic controller of the valve controlling the valve based on the determined position of the actuator.

2. The method of claim 1, further comprising powering the wireless position transducer by a energy storage device included in or proximate to the wireless position transducer.

3. The method of claim 2, further comprising recharging the energy storage device by using at least one of: solar energy, a temporary connection of the energy storage device to a an energy source, recovered energy from a local vibration or movement, or induction from a proximity charger.

4. The method of claim 1, wherein causing the signal to be wirelessly transmitted comprises causing the signal to be wirelessly transmitted over a wireless communication channel, wherein the wireless communication channel is an exclusive connection between the wireless position transducer and the electro-pneumatic controller.

5. The method of claim 1, wherein causing the signal to be wirelessly transmitted comprises causing the signal to be wirelessly transmitted using a HART wireless protocol over a wireless mesh communications network.

6. The method of claim 1, further comprising causing the signal to be wirelessly transmitted using a wireless communication network to a control host of a process plant, the process plant including the valve and the electro-pneumatic controller.

7. A position transducer for use in a process control system, comprising:
a position sensor to detect a position of an actuator coupled to a control device, the control device used in controlling a process operating in the process control system;
a communication interface to transmit a wireless signal indicative of the position of the actuator;
the communication interface coupled to a wireless communication channel;
the wireless communication channel forming an exclusive connection between the position transducer and a controller of the control device; and
a rechargeable energy storage device to power the communication interface.

8. The position transducer of claim 7, wherein the wireless signal is transmitted to at least one of the controller of the control device or a control system host or the process control system.

9. The position transducer of claim 7, wherein a value of a field included in the wireless signal is indicative of the position of the actuator, and wherein a recipient of the wireless signal determines the position of the actuator based exclusively on the value of the field included in the wireless signal.

10. The position transducer of claim 7, wherein the wireless signal is accordance with a wireless HART protocol.

11. The position transducer of claim 7, wherein the wireless communication channel is included in a private wireless mesh communication network of the process control system.

12. The position transducer of claim 11, wherein the wireless signal is transmitted according to a schedule defined by a network manager of the wireless mesh communication network.

13. The position transducer of claim 7, wherein the position sensor includes at least one of a potentiometer, a magnetic sensor, a piezo-electric transducer, a hall effect sensor, or a string potentiometer.

14. The position transducer of claim 7, wherein the control device is a valve.

15. A valve controller, comprising:
a first input to receive a control signal corresponding to a valve;
a second input to receive a wireless position signal from a wireless position transducer via a wireless communication channel, the wireless position signal being indicative of a position of an actuator of the valve;
an output to transmit a drive signal to control the actuator of the valve, the drive signal determined by the valve controller based on the control signal and the wireless position signal; and
wherein the wireless communication channel is an exclusive connection between the wireless position transducer and the valve controller.

16. The valve controller of claim 15, wherein at least one of:
the control signal is in accordance with a wireless HART protocol;
the wireless position signal is in accordance with the wireless HART protocol;
the first input is communicatively connected to a wireless mesh network and the control signal is received according to a schedule generated by a network manager of the wireless mesh network; or
the second input is communicatively connected to the wireless mesh network and the wireless position signal is received according to the schedule generated by the network manager of the wireless mesh network.

17. The valve controller of claim 15, wherein the wireless position signal is in accordance with a wireless HART protocol.

18. The valve controller of claim 15, wherein the wireless communication channel is included in a wireless mesh network, and wherein the wireless position signal is received according to a network schedule generated by a network manager of the wireless mesh network.

19. The valve controller of claim 15, wherein the valve controller determines the drive signal based on a value of a field included in the wireless position signal.

20. The valve controller of claim 15, wherein the wireless position transducer is located in a different environment than the controller.
